(19) United States
(12) Patent Application Publication
(10) Pub. No.: US 2008/0180462 A1
(43) Pub. Date: Jul. 31, 2008

(54) Liquid crystal display device and method of driving liquid crystal display device

(75) Inventor: Takashi Nose, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/007,029

(22) Filed: Jan. 4, 2008

(30) Foreign Application Priority Data
Jan. 26, 2007 (JP) 2007-017033

(51) Int. Cl. G09G 5/10; G09G 3/36

(52) U.S. Cl. 345/690; 345/87

(57) ABSTRACT

A liquid crystal display device includes: a liquid crystal panel; and a driving unit configured to drive the liquid crystal panel. The liquid crystal panel includes: a plurality of scanning lines, a plurality of signal lines and a plurality of pixels. The plurality of scanning lines extends in a first direction. The plurality of signal lines extends in a second direction. The plurality of pixels is arranged in positions where the plurality of scanning lines intersects with the plurality of signal lines. Pixels which are included in the plurality of pixels and aligned along one of the plurality of scanning lines have a same color. The driving unit includes: a plurality of amplifiers configured to drive the plurality of signal lines. The driving unit controls each of the plurality of amplifiers in time sharing such that each of the plurality of amplifiers drives pixels of a first group connected to one scanning line of the plurality of scanning line in the plurality of pixels in a first period in a scanning line selection period, and drives pixels of a second group connected to the one scanning line in a second period in the scanning line selection period.

### BACKGROUND OF THE INVENTION

1. Field of the Invention

The present invention relates to a liquid crystal display device and a method of driving a liquid crystal display device, and more particularly relates to a driving technique for driving a liquid crystal panel configured such that one amplifier drives a plurality of signal lines (data lines) in time sharing.

This application is based upon and claims the benefit of priority from Japanese patent application No. 2007-017033 filed on Jan. 26, 2007, the disclosure of which is incorporated herein in its entirety by reference.

2. Description of Related Art

Under the background that resolution of a liquid crystal panel has been made higher in recent years, the number of the signal lines (data lines) is increased more and more in the liquid crystal panel. In addition, an interval between the signal lines becomes narrower and narrower. One problem resulting from the increase in the number of the signal lines and the narrowing in the interval is that it is difficult to secure a pitch sufficient for external connection wirings through which the signal lines are connected to a driver. The narrowing in the interval between the signal lines leads to the narrowing in the pitch allowable for the external connection wiring, and thus, it becomes difficult to connect the liquid crystal panel and the driver (driving unit) for driving it. Another problem is that the number of the amplifiers included in the driver in order to drive the signal lines is increased. The increase in the number of the amplifiers brings about bad influence such as size increase and cost increase of the driver.

In order to overcome such problems, the driving technique is widely used in which one amplifier is used to drive a plurality of signal lines in the liquid crystal panel in time sharing. For example, Japanese Laid-Open Patent Application JP-A-Heisei, 4-52684 discloses a method of driving a liquid crystal displaying panel. In this driving method, three switching elements mounted in the liquid crystal displaying panel switches between three signal lines and consequently the signal lines is driven in the time sharing.

FIG. 1 is a block diagram showing a configuration of a display device corresponding to the technique disclosed in Japanese Laid Open Patent Application JP-A-Heisei, 4-52684. The display device is configured such that one amplifier drives three signal lines in the time sharing. That is, the display device includes a liquid crystal panel 10 and a driver 20. The liquid crystal panel 10 includes: signal lines DR, DG and DB corresponding to red (R), green (G) and blue (B), respectively; and scanning lines (gate lines) G1, G2, - - - , Gi, - - - , GM. Here, “M” is a natural number equal to or more than two. Also, “i” is a natural number equal to or more than two and equal to or less than M. However, FIG. 1 indicates only i=n, n+1. The signal lines DR, DG and DB are generally referred to as a signal line D when distinction between them is not required. An R-pixel CiR corresponding to the red is placed at a position where the signal line DR intersects with the scanning line Gi. Similarly, a G-pixel CiG corresponding to the green is placed at a position where the signal line DG intersects with the scanning line Gi. Moreover, a B-pixel CiB corresponding to the blue is placed at a position where the signal line DB intersects with the scanning line Gi. Here, “i” in the CiR, CiG and CiB is the same as that in the Gi. One set of the R-pixel CiR, the G-pixel CiG and the B-pixel CiB, which are arranged in a horizontal direction along the same scanning line Gi, constitute a pixel set Pi corresponding to one dot in the liquid crystal panel 10.

Each of the pixels includes a TFT (Thin Film Transistor) 11 and a liquid crystal capacitor 12. The liquid crystal capacitor 12 is composed of a pixel electrode 12a and a common electrode 12b between which the liquid crystal is filled. Sources of the TFTs 11 in the R-pixel CiR, the G-pixel CiG and the B-pixel CiB are connected to the signal lines DR, DG and DB, respectively. Gates of the TFTs 11 in the R-pixel CiR, the G-pixel CiG and the B-pixel CiB are commonly connected to the scanning line Gi. Drains of the TFTs 11 in the R-pixel CiR, the G-pixel CiG and the B-pixel CiB are connected to the pixel electrodes 12a in the liquid crystal capacitors 12 in the R-pixel CiR, the G-pixel CiG and the B-pixel CiB, respectively.

The signal lines DR, DG and DB are connected through switching elements 13R, 13G and 13B to input terminals 14, respectively. The switching elements 13R, 13G and 13B are composed of TFTs formed on the substrate of the liquid crystal panel 10. The switching elements 13R, 13G and 13B are turned on and off, based on control signals S1 to S3 sent from the driver 20, respectively. The input terminal 14 receives a voltage, which is written (applied) to each pixel, from the driver 20. As described later, the write voltages written to the R-pixel CiR, the G-pixel CiG and the B-pixel CiB are serially supplied to the input terminals 14. The switching elements 13R, 13G and 13B are sequentially and exclusively turned on and off such that the write voltages written to the R-pixel CiR, the G-pixel CiG and the B-pixel CiB are supplied to the corresponding signal lines DR, DG and DB. Hereafter, there is a case that the switching elements 13R, 13G and 13B are merely generally referred to as the switching elements 13.

The driver 20 includes a shift register 21, a data register 22, a latch 23, a D/A converter 24 and an amplifier 25. The shift register 21 shifts a supplied clock signal CLK and generates a shift pulse. The data register 22 latches a supplied data signal by using the received shift pulse as a trigger to sequentially obtain the data signals. The data signal is an RGB data for specifying a grayscale of each pixel. The latch 23 sequentially latches the RGB data from the data register 22. Then, the latch 23 sequentially supplies the latched RGB data to the D/A converter 24. The D/A converter 24 selects a desirable grayscale voltage from a plurality of supplied grayscale voltages, based on the sequentially supplied RGB data. Then, the D/A converter 24 sequentially supplies the selected grayscale voltage to the amplifier 25. The amplifier 25 sequentially supplies the write voltage, which corresponds to the grayscale voltage supplied from the D/A converter 24, to the input terminal 14 in the liquid crystal panel 10.

The driver 20 further includes a control circuit 26 for generating the control signals S1 to S3. The control circuit 26 supplies the control signals S1 to S3 to the corresponding switching elements 13 and selectively turns on the desirable switching element 13. The control circuit 26 carries out the timing control so that the timings when the amplifier 25 supplies the write voltages to the input terminal 14 and the timings of the control signals S1 to S3 are synchronous. With this timing control, the switching element 13 is turned on and off such that the desirable write voltage is supplied to the desirable signal line in synchronization with the supply to the input terminal 14 of the write voltage. The control circuit 26 carries out the timing control based on a program stored in a storage unit (not shown) in the driver 20.

The writings of the write voltages to an R-pixel CnR, a G-pixel CnG and a B-pixel CnB on an n-th line in the display device are typically executed in accordance with the following sequence.

At first, a scanning line decoder (not shown) activates the scanning lines Gn, which are connected to the R-pixel CnR, the G-pixel CnG and the B-pixel CnB (the pixel set Pn) on the n-th line, in response to the control signal from the driver 20. Thus, the TFTs 11 of the R-pixel CnR, the G-pixel CnG and the B-pixel CnB are turned on. Hence, the R-pixel CnR, the G-pixel CnG and the B-pixel CnB become in the writable states. Moreover, the amplifier 25 supplies the write voltage, which is written to the R-pixel CnR, to the input terminal 14. In synchronization with the supply of the write voltage, the control circuit 26 selects the signal line DR by using the control signal S1. That is, the switching element 13R is turned on, and the other switching elements 13G, 13B are turned off. Consequently, the signal line DR is connected to the input terminal 14, and the other signal lines DG, DB become in high impedance states. As a result, the write voltage, which is written to the R-pixel CnR, is supplied through the signal line DR to the R-pixel CnR and written to the R-pixel CnR. That is, the write voltage is applied to the liquid crystal capacitor 12 of the G-pixel CnG.

In succession, the amplifier 25 supplies the write voltage, which is written to the G-pixel CnG, to the input terminal 14. In synchronization with the supply of the write voltage, the control circuit 26 selects the signal line DG by using the control signal S2. Thus, the signal line DG is connected to the input terminal 14, and the write voltage is written through the signal line DG to the G-pixel CnG. That is, the write voltage is applied to the liquid crystal capacitor 12 of the G-pixel CnG.

In succession, the amplifier 25 supplies the write voltage, which is written to the B-pixel CnB, to the input terminal 14. In synchronization with the supply of the write voltage, the control circuit 26 selects the signal line DB by using the control signal S3. Thus, the signal line DB is connected to the input terminal 14, and the write voltage is written through the signal line DB to the B-pixel CnB. That is, the write voltage is applied to the liquid crystal capacitor 12 of the B-pixel CnB.

In accordance with the foregoing sequence, the driver 20 drives the signal lines DR, DG and DB in the time sharing, and the write voltage is written to the corresponding pixel. The writing of the write voltages is carried out in the order of the R-pixel CnR, the G-pixel CnG and the B-pixel CnB.

Japanese Laid Open Patent Application JP-A-Heisei, 4-52684 discloses the fact that the signal line is not always required to correspond to the RGB and that the number of the signal lines driven by one amplifier may be two or four or more.

As a related art, Japanese Laid Open Patent Application JP-A-Heisei, 10-293285 (corresponding to UK patent Application No. GB2320790A) discloses a pixel array structure, a liquid crystal display device using the pixel array structure and a method of driving the liquid crystal display device. In this color filter pixel array structure, a plurality of unit color filter pixels in which R, G and B are arranged in turn in a direction substantially orthogonal to a scanning direction are arrayed in a matrix style. Together with it, this is characterized in that the color filter pixels on even-numbered rows are arranged to protrude from the color filter pixels on adjacent odd-numbered rows, by a constant distance in the scanning direction. This document also discloses that the pixels connected to one scanning line have the same color.

Japanese Laid Open Patent Application JP-P 2001-109435A discloses a display device. This display device includes an array substrate and a signal line driving means. The array substrate includes: a plurality of gate lines and a plurality of signal lines, which are arranged orthogonally to each other on the substrate; pixel transistors arranged at the respective intersections between the gate lines and the signal lines; and pixel electrodes connected to the respective pixel transistors, on an insulating substrate. The signal line driving means outputs analog image signals to the signal lines. In this display device, the signal line driving means includes a driver IC and a selecting means. The driver IC converts input digital signals into analog signals. The driver IC also divides the signal lines into a plurality of signal line groups composed of the predetermined number of the signal lines and serially outputs the corresponding analog signal for each of the signal line groups. The selecting means is integrally formed on the array substrate and sequentially distributes the serial analog signal from the drive IC to the corresponding signal line of each of the signal line groups. This document discloses the technique in which the selecting circuit formed on the display panel substrate is used to switch the two signal lines.

Japanese Laid Open Patent Application JP-P 2001-337657A (corresponding to U.S. Pat. No. 6,989,810B2) discloses a liquid crystal display device. This liquid crystal display device includes: signal lines and scanning lines, which are longitudinally and laterally arranged, respectively; and pixel transistors formed near the intersections between the signal lines and the scanning lines. This liquid crystal display device includes a plurality of first latch circuits, a plurality of second latch circuits, a plurality of D/A converting circuits, and a signal line selecting circuit. The plurality of first latch circuits latches digital grayscale data composed of a plurality of bits at timings different from each other. The plurality of second latch circuits is provided correspondingly to the plurality of first latching circuits, respectively, and latches the latch data, which are latched by the plurality of first latch circuits, respectively, in the same timing. The plurality of D/A converting circuits is provided correspondingly to the plurality of second latching circuits, respectively, and converts the latch data, which are latched by the plurality of second latch circuits, respectively, into analog grayscale voltages. The signal line selecting circuit switches whether or not the analog grayscale voltages are supplied to the respective signal lines such that the signal lines are driven in each of a plurality of times with respect to each of a plurality of signal lines. This document discloses the technique in which the six signal lines are switched by six analog switches.

We have now discovered a following fact. One problem in the foregoing driving techniques is that, after the signal line becomes in the high impedance state, the write voltage held in the liquid crystal capacitor 12 in each pixel is varied from the desirable write voltage. The reason of the variation in the write voltage is a leakage in the TFT constituting the switching element 13 that is used to switch the signal line D. The signal line D shown in FIG. 1 is long in its length and high in resistance and capacitance which correspond to the length. For this reason, in order to drive the signal line D, the high driving performance is required for the TFT constituting the switching element 13. Thus, the TFT is formed such that its gate width is wide, its gate length is short, and its on resistance is small. However, the leakage in a TFT designed based on the above concept is essentially high. For this reason, charges accumulated in the pixel electrode 12a in each pixel are discharged through the TFT constituting the switching element 13, and the write voltage of the pixel is decreased. When the write voltages supplied to the adjacent signal lines are largely different, this leakage problem becomes more and more important.

Moreover, the variation in the write voltage becomes severe as the number of the signal lines for each amplifier is increased. For this reason, in the liquid crystal panel in which the six or more signal lines are driven in the time sharing, the variation in the write voltage further severely arises, although this method has been considered in recent years.

The variation in the write voltage as mentioned above is recognized as brightness irregularity by a person who observes the liquid crystal panel 10. Specifically, the variation in the write voltage is recognized as the pattern extending in a longitudinal direction (a direction of the signal line D), namely, a longitudinal unevenness.

FIG. 2 is a block diagram showing a configuration of a liquid crystal panel in which six signal lines are driven in the time sharing. Each component is basically similar to FIG. 1, except the six switching elements 13 are used for the six signal lines D. FIG. 3 is a timing chart showing an example of waveforms of signals supplied to the liquid crystal panel. The reference letters VGn, VGn+1 indicate the voltage waveforms to select the scanning lines Gn, Gn+1, respectively. The reference letters S1 to S6 indicate the voltage waveforms to select the switching elements 13R1 to 13B2, respectively. FIG. 4 is a view showing an example of a writing order to the respective pixels on the liquid crystal panel. In FIG. 4, rectangles indicate the pixels, and numerals in the pixels indicate the writing order. The reference letters R1 and the like and Gn and the like are similar to FIG. 2.

For example, as shown in FIGS. 2, 3 and 4, in the writing order, the write voltages are written to the respective pixels in the order of the R1-pixel Cn1R, the G1-pixel Cn1G, the B1-pixel Cn1B, the R2-pixel Cn2R, the G2-pixel Cn2G and the B2-pixel Cn2B, in one scanning line selection period. At this time, the time of the leakage after the writing voltages are written to the respective pixels becomes long in the order of the B2-pixel Cn2B, G2-pixel Cn2G, R2-pixel Cn2R, the B1-pixel Cn1B, the G1-pixel Cn1G and the R1-pixel Cn1R. For this reason, for example, in the case of the single color displaying of the red (R), since the leakage times of the R1-pixel Cn1R and the R2-pixel Cn2R are long, the variation amounts in the write voltages in those pixels are relatively large, which severely causes the longitudinal unevenness.

Japanese Laid-Open Patent Application JP-P 2001-109435A discloses a technique in which, in a display device for driving two signal lines by one amplifier, the writing order to the signal lines is changed for each at least one of predetermined vertical scanning period and horizontal scanning period (refer to the paragraphs [0031] to [0043] in JP-P 2001-109435A). This technique enables the pixel, in which the variation in the write voltage arises, to be deconcentrated temporally or spatially. Thus, occurrence of the longitudinal unevenness is suppressed. However, such a suppressing method involves a new problem such as graininess or flicker, because the substantial variation in the write voltage is not reduced.

### SUMMARY

The present invention seeks to solve one or more of the above problems, or to improve upon those problems at least in part. In one embodiment, a liquid crystal display device includes: a liquid crystal panel; and a driving unit configured to drive the liquid crystal panel. The liquid crystal panel includes: a plurality of scanning lines configured to extend in a first direction, a plurality of signal lines configured to extend in a second direction, and a plurality of pixels configured to be arranged in positions where the plurality of scanning lines intersects with the plurality of signal lines, wherein pixels which are included in the plurality of pixels and aligned along one of the plurality of scanning lines have a same color. The driving unit includes: a plurality of amplifiers configured to drive the plurality of signal lines. The driving unit controls each of the plurality of amplifiers in time sharing such that each of the plurality of amplifiers drives pixels of a first group connected to one scanning line of the plurality of scanning line in the plurality of pixels in a first period in a scanning line selection period, and drives pixels of a second group connected to the one scanning line in a second period in the scanning line selection period.

According to the present invention, in array of pixels, pixels connected to each scanning line have the same color, and an R-pixel, a G-pixel and a B-pixel constituting one pixel are arranged in a vertical direction. In this case, when an image with single color is displayed, charge between pixels adjacent to each other in a scanning line direction is approximately equal to each other. Therefore, even though a method of driving a plurality of signal lines by one amplifier in time-sharing, a leakage current through a switch element can be suppressed. Consequently, brightness unevenness caused by variation in a write voltage to the pixel can be suppressed while color evenness on the liquid crystal panel is improved.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram showing a configuration of a display device in a related art;

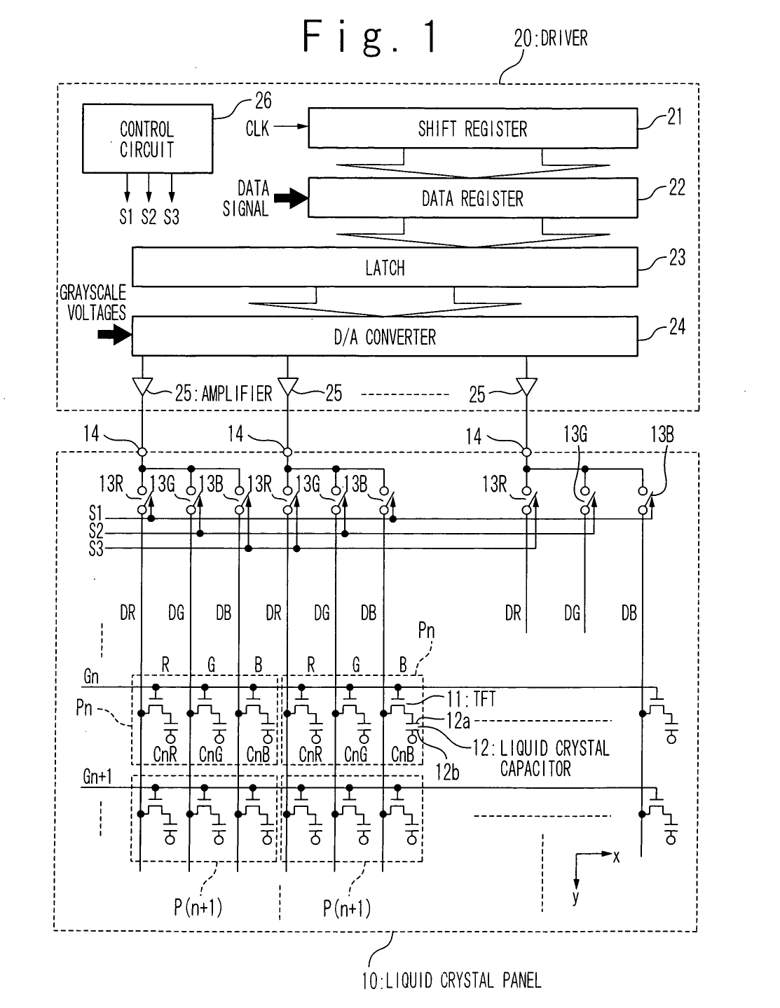

FIG. 2 is a block diagram showing a configuration of a liquid crystal panel in a related art;

FIG. 3 is a timing chart showing an example of waveforms of signals supplied to a liquid crystal panel in a related art;

FIG. 4 is a view showing an example of a writing order to respective pixels on the liquid crystal panel in a related art;

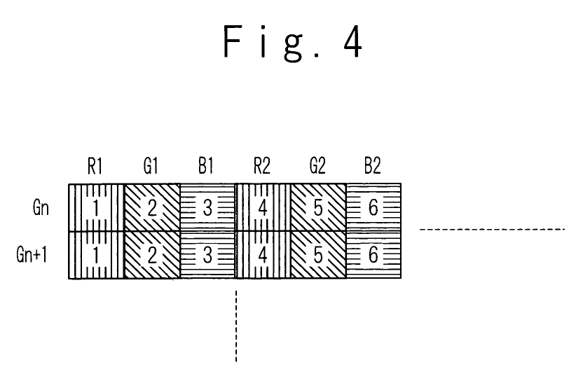

FIG. 5 is a block diagram showing a configuration of an embodiment of a liquid crystal display device according to the present invention;

FIG. 6 is a view showing a pixel configuration of pixel sets Pn1, Pn2 on a liquid crystal panel according to the present invention;

FIG. 7 is a timing chart showing an operation of the embodiment of the liquid crystal display device according to the present invention;

FIG. 8 is a view showing a writing order to respective pixels on the liquid crystal panel in a method of driving the liquid crystal display device of the present invention;

FIG. 9 is a block diagram showing a configuration of another embodiment of the liquid crystal display device of the present invention;

FIG. 10 is a timing chart explaining an operation method in another embodiment of the liquid crystal display device of the present invention; and

FIG. 11 is a graph showing a relation between a transmissivity and a grayscale voltage.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

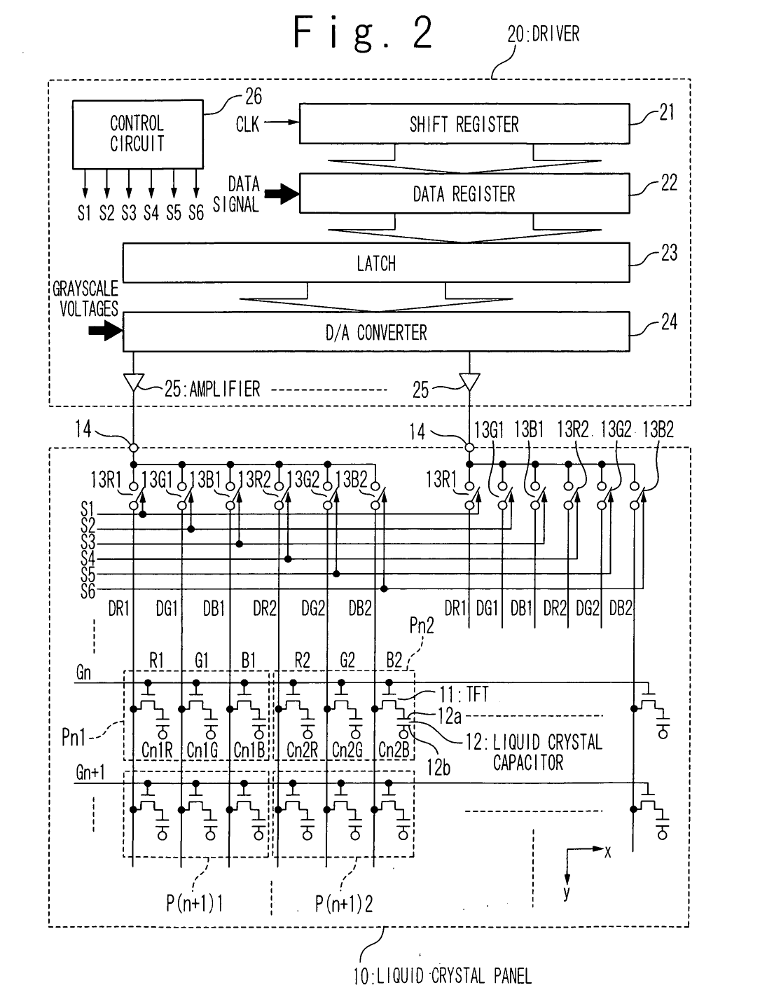

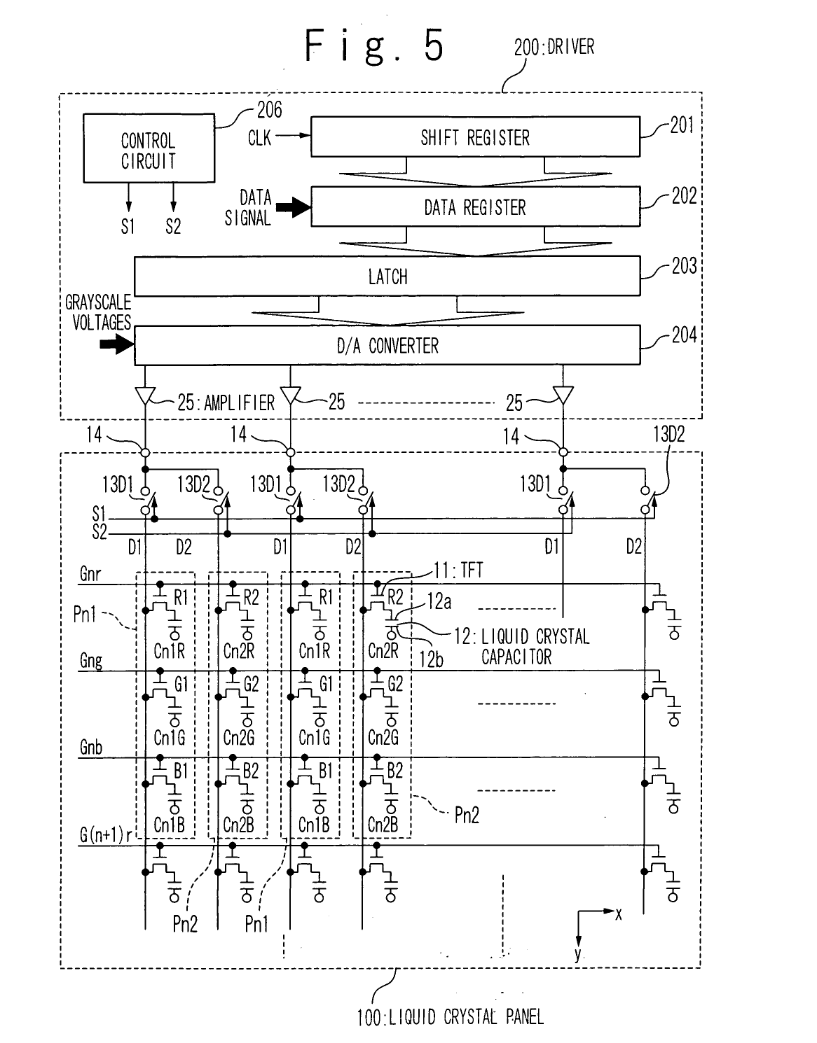

The embodiments of a liquid crystal display device and a method of driving the liquid crystal display device according to the present invention will be described below with reference to the attached drawings. FIG. 5 is a block diagram showing a configuration of the embodiment of the liquid crystal display device according to the present invention. Incidentally, in FIG. 5, the same or similar reference letters are given to components having the functions similar to the components of FIG. 2.

This liquid crystal display device includes a liquid crystal panel 100 and a driver 200. The liquid crystal panel 100 includes a plurality of scanning lines (gate lines) G, a plurality of signal lines (data lines) D and a plurality of pixels P.

The plurality of scanning lines G includes scanning lines G1r, G1g, G1b, G2r, G2g, G2b, - - - , Gir, Gig, Gib, - - - , GMr, GMg and GMb. Each of the plurality of scanning lines G extends in an X-direction. Here, each suffix numeral of “G” indicates a serial number of the scanning line. Here, “M” is a natural number equal to or more than two. Also, “i” is a natural number equal to or more than two and equal to or less than M. The suffixes “r”, “g” and “b” of “G” indicate that they correspond to the red (R), the green (G) and the blue (B), respectively. FIG. 5 indicates only a part, such as i=n and i=n+1. The plurality of signal lines D includes signal lines D1 belonging to a first group and signal lines D2 belonging to a second group. The signal lines D1 and the signal line D2 are alternately arranged and extend in a Y-direction. Here, only the two sets of the signal lines D1 and the signal lines D2 are shown in FIG. 5.

An R-pixel Ci1R corresponding to the red is placed at a position where the signal line D1 intersects with the scanning line Gir. Similarly, a G-pixel Ci1G corresponding to the green is placed at a position where the signal line D1 intersects with the scanning line Gig. A B-pixel Ci1B corresponding to the blue is placed at a position where the signal line D1 intersects with the scanning line Gib. Also, an R-pixel Ci2R corresponding to the red is placed at a position where the signal line D2 intersects with the scanning line Gir. Similarly, a G-pixel Ci2G corresponding to the green is placed at a position where the signal line D2 intersects with the scanning line Gig. A B-pixel Ci2B corresponding to the blue is placed at a position where the signal line D2 intersects with a scanning line Gib. Here, the suffix “i” of “C” indicates the serial number of the scanning line as described above. The suffixes “1” and “2” of “C” indicate the signal line D1 and the signal line D2, respectively. The suffixes “R”, “G” and “B” of “C” indicate that they correspond to the red (R), the green (G) and the blue (B), respectively.

Here, one set of the R-pixel Ci1R, the G-pixel Ci1G and the B-pixel Ci1B, which are arranged in the vertical direction along the same signal line D1, constitutes a pixel set Pi1 corresponding to one dot of the liquid crystal panel 100. Similarly, one set of the R-pixel Ci2R, the G-pixel Ci2G and the B-pixel Ci2B, which are arranged in the vertical direction along the same signal line D2, constitutes a pixel set Pi2. Here, the suffix “i” of “P” indicates the serial number of the scanning line as described above. The suffixes “1” and “2” of “P” indicate the signal line D1 and the signal line D2, respectively.

Also, the pixels arranged in the horizontal direction along the scanning line Gir are the R-pixel Ci1R and the R-pixel Ci2R, and only the pixels corresponding to the red (R) are arranged. Similarly, the pixels arranged in the horizontal direction along the scanning line Gig are the G-pixel Ci1G and the G-pixel Ci2G, and only the pixels corresponding to the green (G) are arranged. The pixels arranged in the horizontal direction along the scanning line Gib are the B-pixel Ci1B and the B-pixel Ci2B, and only the pixels corresponding to the blue are arranged. That is, the pixels arranged along the same scanning line G has the same color.

Each of the pixels includes a TFT (Thin Film Transistor) 11 and a liquid crystal capacitor 12. The liquid crystal capacitor 12 is composed of a pixel electrode 12a and a common electrode 12b between which the liquid crystal is filled. In the TFT 11s of the R-pixel Ci1R, the G-pixel Ci1G and the B-pixel Ci1B, all of the sources are connected to the signal line D1, and the gates are connected to the scanning lines Gir, Gig and Gib, respectively. Also, in the TFT 11s of the R-pixel Ci2R, the G-pixel Ci2G and the B-pixel Ci2B, all of the sources are connected to the signal line D2, and the gates are connected to the scanning lines Gir, Gig and Gib, respectively. All of the drains are connected to the pixel electrode 12a in the liquid crystal capacitor 12 in each pixel.

The signal lines D1, D2 are connected through switching elements 13D1, 13D2 to input terminals 14, respectively. The switching elements 13D1, 13D2 are constituted by the TFTs formed on the substrate of the liquid crystal panel 100. Each of the switching elements 13D1, 13D2 is turned on and off, in response to the control signals S1, S2 supplied from the driver 200. The input terminal 14 receives the voltage, which is written to each pixel, from the driver 200. As described later, the write voltages written to the R-pixels Ci1R, Ci2R are serially supplied to the input terminals 14. The switching elements 13D1, 13D2 are sequentially exclusively turned on and off such that the write voltages written to the R-pixels Ci1R, Ci2R are supplied to the corresponding signal lines D1, D2. Similarly, the write voltages written to the G-pixels Ci1G, Gi2G are serially supplied to the input terminals 14. The switching elements 13D1, 13D2 are sequentially exclusively turned on and off such that the write voltages written to the G-pixels Ci1G, Ci2G are supplied to the corresponding signal lines D1, D2. The write voltages written to the B-pixels Ci1B, Ci2B are serially supplied to the input terminals 14. The switching elements 13D1, 13D2 are sequentially exclusively turned on and off such that the write voltages written to the B-pixels Ci1B, Ci2B are supplied to the corresponding signal lines D1, D2. Hereafter, there is a case that the switching elements 13D1, 13D2 are merely generally referred to as the switching elements 13.

The driver 200 includes a shift register 201, a data register 202, a latch 203, a D/A converter 204 and an amplifier 25. The shift register 201 shifts a supplied clock signal CLK and generates a shift pulse. The data register 202 latches a supplied data signal by using the received shift pulse as a trigger to sequentially obtain the data signals. The data signal is an RGB data for specifying a grayscale of each pixel. The latch 203 sequentially latches the RGB data from the data register 202. Then, the latch 203 sequentially supplies the latched RGB data to the D/A converter 204. The D/A converter 204 selects a desirable grayscale voltage from a plurality of supplied grayscale voltages, based on the sequentially supplied RGB data. Then, the D/A converter 204 sequentially supplies the selected grayscale voltage to the amplifier 25. The amplifier 25 sequentially supplies the write voltage, which corresponds to the grayscale voltage supplied from the D/A converter 204, to the input terminals 14 in the liquid crystal panel 100.

The driver 200 further includes a control circuit 206 for generating the control signals S1, S2. The control circuit 206 supplies the control signals S1, S2 to the corresponding switching elements 13D1, 13D2 and selectively turns on the desirable switching elements 13D, 13D2. The control circuit 206 carries out the timing control so that the timings when the amplifier 25 supplies the write voltages to the input terminals 14 and the timings of the control signals S1, S2 are synchronous. With this timing control, the switching elements 13D1, 13D2 are turned on and off such that the desirable write voltage is supplied to the desirable signal line in synchronization with the supply to the input terminal 14 of the write voltage. The control circuit 206 carries out the timing control based on a program stored in a storage unit (not shown) in the driver 200. That is, the control circuit 206 controls the amplifier 25 and the switching elements 13D1, 13D2 in the time sharing, such that the amplifier 25 drives the pixel (e.g. Cn1R) of the first group connected to one scanning line (e.g. Gnr) among the plurality of pixels, in the first period in one scanning line selection period and drives the pixel (e.g. Cn2R) of the second group connected to the one scanning line (e.g. Gnr), in the second period in one scanning line selection period.

When the liquid crystal panel 100 of the present invention shown in FIG. 5 is compared with the liquid crystal panel 10 shown in FIG. 2, the number of the scanning lines is three times, and the number of the signal lines is ⅓.

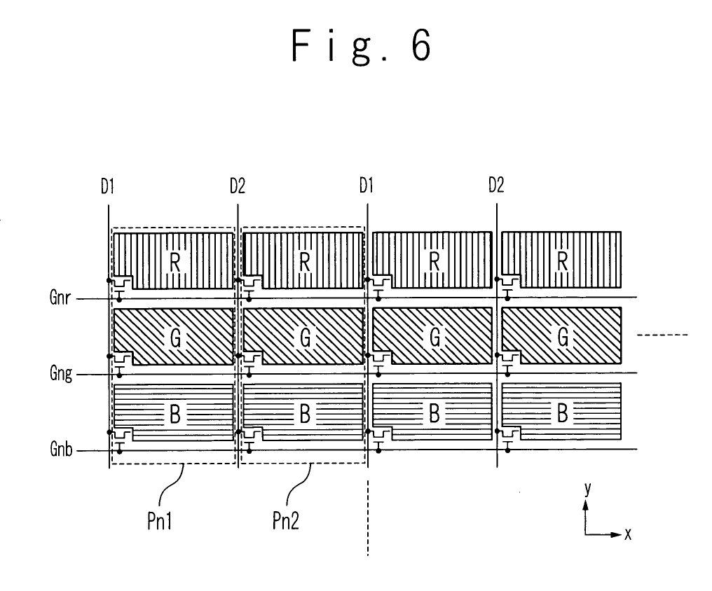

FIG. 6 is a view showing a pixel configuration of the pixel sets Pn1, Pn2 on the liquid crystal panel according to the present invention. Along the signal line D1, the respective pixels of the red (R), the green (G) and the blue (B) are arranged, thereby constituting the pixel set Pn1 of the first group. Similarly, along the signal line D2, the respective pixels of the red (R), the green (G) and the blue (B) are arranged, thereby constituting the pixel set Pn2 of the second group. On the other hand, along the scanning line Gnr, the pixels of the red (R) of the same color are arranged. Similarly, along the scanning line Gng, the pixels of the green (G) of the same color are arranged. Along the scanning line Gnb, the pixels of the blue (B) of the same color are arranged.

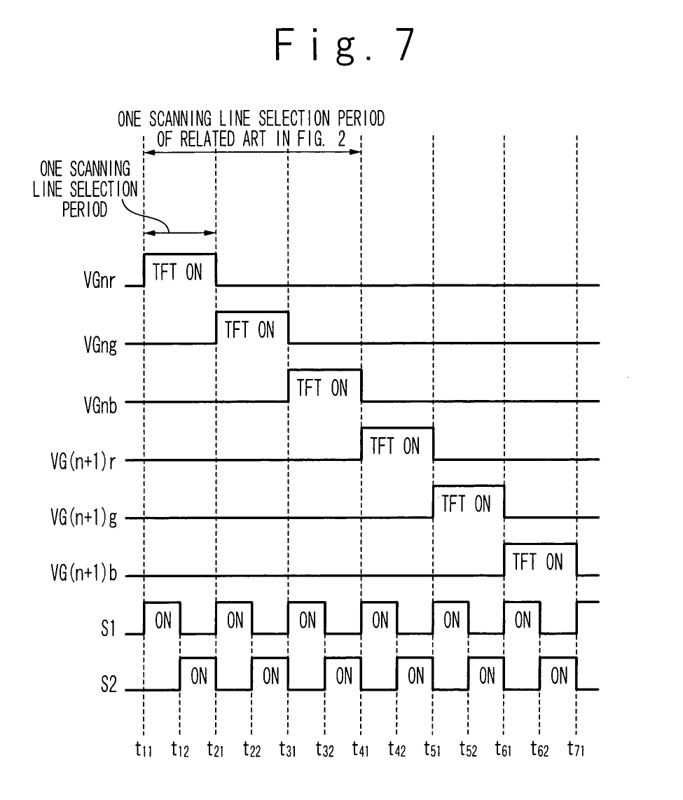

An operation of the embodiment of the liquid crystal display device (a method of driving the liquid crystal display device) according to the present invention will be described below with reference to FIGS. 6, 7. Here, FIG. 7 is a timing chart showing an operation of the embodiment of the liquid crystal display device according to the present invention. Here, the operation from the scanning line Gnr is explained as an example.

(1) t11 to t21

At first, the scanning line decoder (not shown) activates the scanning lines Gnr, which is connected to the R-pixel Cn1R and the R-pixel Cn2R on the n-th line, in response to the control signal from the driver 200. Thus, the TFTs 11 in the R-pixel Cn1R and the R-pixel Cn2R are turned on. Hence, the R-pixel Cn1R and the R-pixel Cn2R become in the writable state. The amplifier 25 serially supplies the write voltages, which are written to the R-pixel Cn1R and the R-pixel Cn2R, to the input terminal 14.

In succession, at the t11, when the write voltage written to the R-pixel Cn1R is supplied to the input terminal 14, the control circuit 206 outputs the control signal S1 in synchronization with the supply of the write voltage. Thus, the switching element 13D1 is turned on, and the signal line D1 is selected. At this time, since the control signal S2 is not outputted, the switching element 13D2 is off. As a result, the write voltage written to the R-pixel Cn1R is supplied through the signal line D1 to the R-pixel Cn1R.

After that, at the t21, when the write voltage written to the R-pixel Cn2R is supplied to the input terminal 14, the control circuit 206 outputs the control signal S2 in synchronization with the supply of the write voltage. Thus, the switching element 13D2 is turned on, and the signal line D2 is selected. At this time, since the control signal S1 is not outputted, the switching element 13D1 is off. As a result, the write voltage written to the R-pixel Cn2R is supplied through the signal line D2 to the R-pixel Cn2R.

In this way, the control circuit 206 sequentially and exclusively turns on and off the switching elements 13D1, 13D2 so that the write voltages written to the R-pixel Cn1R and the R-pixel Cn2R are supplied to the corresponding signal lines D1, D2.

(2) t21 to t31

Next, the scanning line decoder (not shown) activates the scanning lines Gng, which is connected to the G-pixel Cn1G and the G-pixel Cn2G on the n-th line, in response to the control signal from the driver 200. Thus, the TFTs 11 in the G-pixel Cn1G and the G-pixel Cn2G are turned on. Hence, the G-pixel Cn1G and the G-pixel Cn2G become in the writable state. The amplifier 25 serially supplies the write voltages, which are written to the G-pixel Cn1G and the G-pixel Cn2G, to the input terminal 14.

In succession, at the t21, when the write voltage written to the G-pixel Cn1G is supplied to the input terminal 14, the control circuit 206 outputs the control signal S1 in synchronization with the supply of the write voltage. Thus, the switching element 13D1 is turned on, and the signal line D1 is selected. At this time, since the control signal S2 is not outputted, the switching element 13D2 is off. As a result, the write voltage written to the G-pixel Cn1G is supplied through the signal line D1 to the G-pixel Cn1G.

After that, at the t22, when the write voltage written to the G-pixel Cn2G is supplied to the input terminal 14, the control circuit 206 outputs the control signal S2 in synchronization with the supply of the write voltage.

Thus, the switching element 13D2 is turned on, and the signal line D2 is selected. At this time, since the control signal S1 is not outputted, the switching element 13D1 is off. As a result, the write voltage written to the G-pixel Cn2G is supplied through the signal line D2 to the G-pixel Cn2G.

In this way, the control circuit 206 sequentially and exclusively turns on and off the switching elements 13D1, 13D2 so that the write voltages written to the G-pixel Cn1G and the G-pixel Cn2G are supplied to the corresponding signal lines D1, D2.

(3) t31 to t41

Next, the scanning line decoder (not shown) activates the scanning lines Gnb, which is connected to the B-pixel Cn1B and the B-pixel Cn2B on the n-th line, in response to the control signal from the driver 200. Thus, the TFTs 11 in the B-pixel Cn1B and the B-pixel Cn2B are turned on. Hence, the B-pixel Cn1B and the B-pixel Cn2B become in the writable state. The amplifier 25 serially supplies the write voltages, which are written to the B-pixel Cn1B and the B-pixel Cn2B, to the input terminal 14.

In succession, at the t31, when the write voltage written to the B-pixel Cn1B is supplied to the input terminal 14, the control circuit 206 outputs the control signal S1 in synchronization with the supply of the write voltage. Thus, the switching element 13D1 is turned on, and the signal line D1 is selected. At this time, since the control signal S2 is not outputted, the switching element 13D2 is off. As a result, the write voltage written to the B-pixel Cn1B is supplied through the signal line D1 to the B-pixel Cn1B.

After that, at the t32, when the write voltage written to the B-pixel Cn2B is supplied to the input terminal 14, the control circuit 206 outputs the control signal S2 in synchronization with the supply of the write voltage. Thus, the switching element 13D2 is turned on, and the signal line D2 is selected. At this time, since the control signal S1 is not outputted, the switching element 13D1 is off. As a result, the write voltage written to the G-pixel Cn2G is supplied through the signal line D2 to the B-pixel Cn2B.

In this way, the control circuit 206 sequentially and exclusively turns on and off the switching elements 13D1, 13D2 so that the write voltages written to the B-pixel Cn1B and the B-pixel Cn2B are supplied to the corresponding signal lines D1, D2.

The next (n+1)-th line or after, similarly, the scanning lines G(n+1)r, G(n+1)g and G(n+1)b are sequentially selected. Then, at the respective selections, the signal lines D1, D2 are sequentially selected. Consequently, the write voltages are sequentially supplied to the R-pixel C (n+1) 1R, the R-pixel C(n+1)2R, the G-pixel C(n+1)1G, the G-pixel C(n+1)2G, the B-pixel C(n+1) 1B and the B-pixel C(n+1) 2B.

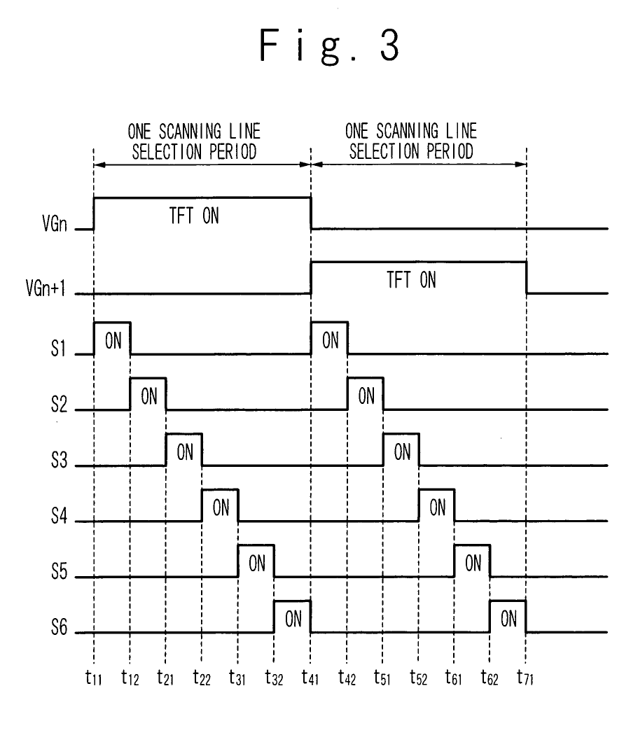

In FIG. 7, in the one scanning line selection period (e.g. t11 to t21, t21 to t31, t31 to t41, t41 to t51, t51 to t61, and t61 to t71), the control signals S1, S2 for controlling the respective switching elements 13 are turned on in turn, and the writings to the respective pixels connected to the respective signal lines D are executed. The number of the scanning lines G on the liquid crystal panel of the present invention becomes three times that of the related art case shown in FIG. 2. Thus, one scanning line selection period (e.g. t11 to t21 in FIG. 7) in which one scanning line G is selected for the scan is ⅓ of the one scanning line selection period (e.g. t11 to t41 in FIG. 3) of the related art case (FIG. 2). However, the on-period (e.g. t11 to t12 in FIG. 7) while the switching control signals S1, S2 are used to execute the writings to the respective signal lines D becomes the same time as the on-period (e.g. t11 to t12 in FIG. 3) of the related art case (FIG. 2).

In the related art case (FIG. 2), in the one scanning line selection period in which each scanning line G is selected (e.g. t11 to t41 in FIG. 2), the signal line D of the six lines is separately driven. On the contrary, in the present invention (FIG. 7), in one scanning line selection period in which each scanning line G is selected (e.g. t11 to t21 in FIG. 7), only the signal line D of the two lines is separately driven. Thus, the time while the leakage current from the switching elements 13D connected to the respective signal lines G can be reduced to ⅓ of the related art case (FIG. 2).

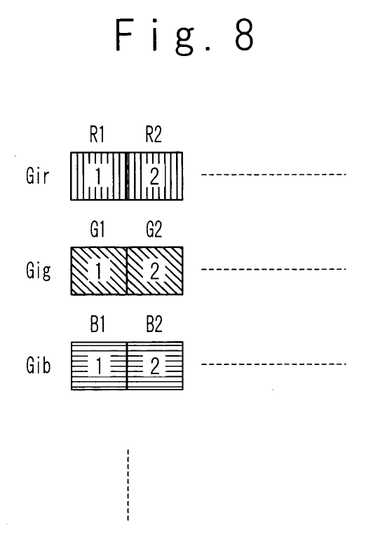

Also, FIG. 8 is a view showing a writing order to the respective pixels on the liquid crystal panel in the method of driving the liquid crystal display device according to the present invention. The rectangles indicate the pixels, and the numerals in the pixels indicate the writing order.

The reference letters R1, R2, G1, G2, B1 and B2 indicate Ci1R, Ci2R, Ci1G, Ci2G, Ci1B and Ci2B, respectively. The pixels of the same color connected to the respective scanning lines Gir, Gig or Gib, namely, the R-pixel, the G-pixel or the B-pixel are written in the order from R1 to R2, from G1 to G2 and from B1 to B2 in the horizontal direction, respectively. Here, in the foregoing driving method, in the case that the polarity inverting method of the liquid crystal panel 100 is limited to the gate line inversion in which the polarities of the respective pixels in the scanning line direction are equal, for example, in the case of the single color displaying of the red, the write voltages of the R1-pixel Cn1R and the R2-pixel Cn2R become equal in potential, which the leakage current from the switching element 13D does not occur. Thus, the longitudinal unevenness in the single color displaying, which occurs in the multiplexing drive equal to or larger than six divisions in the related art, can be further suppressed.

Also, in the foregoing driving method, when the image data corresponding to one frame is displayed, each set of the red (R) scanning line Gir, the green (G) scanning line Gig and the blue (B) scanning line Gib are driven in turn, correspondingly to one horizontal scanning line in the one frame. In this case, the control can be easily executed as compared with the case disclosed in JP-A-Heisei, 10-293285 (corresponding to UK patent Application No. GB2320790A). In the case disclosed in JP-A-Heisei, 10-293285, correspondingly to all of the horizontal scanning lines in the one frame, all of the red (R) scanning lines are driven one time and then all of the green (G) scanning lines are driven and then all of the blue (B) scanning lines are driven.

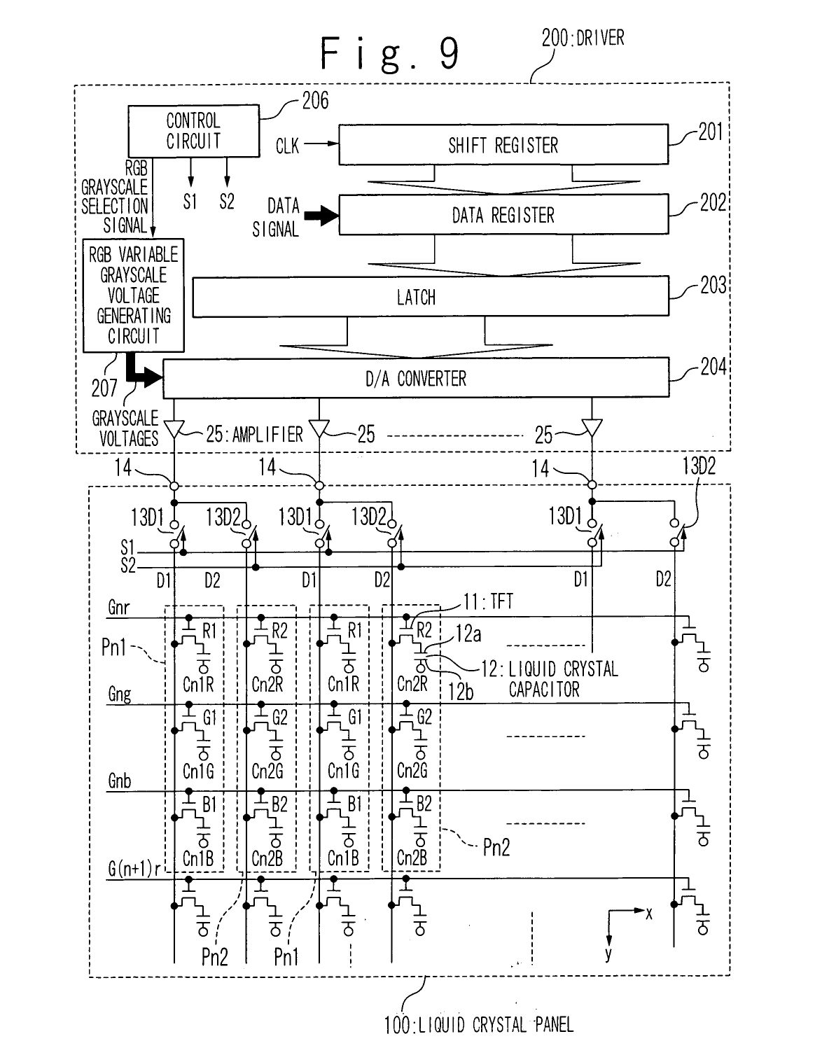

Another embodiment of the liquid crystal display device and the method of driving the liquid crystal display device according to the present invention will be described below with reference to the attached drawings. FIG. 9 is a block diagram showing a configuration of another embodiment of the liquid crystal display device according to the present invention. Incidentally, in FIG. 9, the same or similar reference letters are given to components having the functions similar to those of the components in FIG. 5.

This liquid crystal display device differs from the embodiment in FIG. 5 in that the driver 200 further includes an RGB variable grayscale voltage generating circuit 207. Since the other configurations are similar to those of the foregoing embodiment, their explanations are omitted.

The RGB variable grayscale voltage generating circuit 207 generates reference grayscale voltages corresponding to grayscale voltage properties in respective colors of the red (R), the green (G) and the blue (B) on the liquid crystal panel 100, based on an RGB grayscale selection signal from the control circuit 206. The RGB variable grayscale voltage generating circuit 207 switches the grayscale voltage property corresponding to the input grayscale data applied through the signal line D to each reference grayscale voltage corresponding to the grayscale voltage property of each of the colors of the red, the green and the blue, for each scanning of the scanning lines of the respective colors of the red, the green and the blue, with respect to the pixels P of the same color that are driven in the time sharing and arranged along the scanning line G.

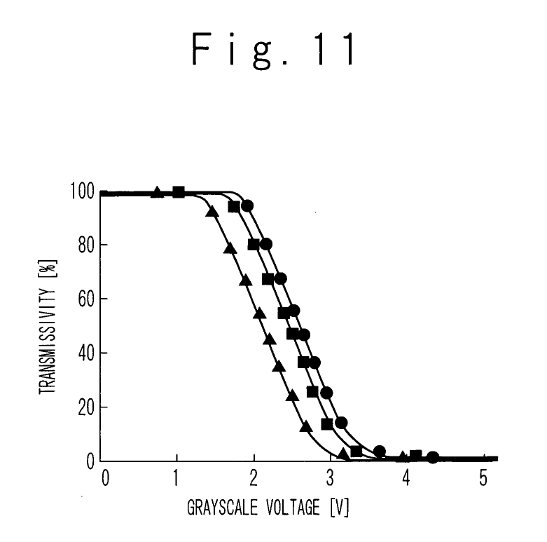

FIG. 11 is a graph showing a relation between a transmissivity and a grayscale voltage. The vertical axis indicates the transmissivity of the light transmitted in each pixel. The horizontal axis indicates the grayscale voltage applied to each pixel. A triangle mark indicates the red (R) grayscale voltage, a round indicates the green (G) grayscale voltage, and a rectangle indicates the blue (B) grayscale voltage. In this way, on the liquid crystal panel 100, even if the same grayscale voltage is applied, the transmissivity of the light is different. Thus, the grayscale voltage is required to be controlled for each color. The RGB variable grayscale voltage generating circuit 207 generates the grayscale voltage as represented in this graph, for each color.

Adding the RGB variable grayscale voltage generating circuit 207 can attain the gamma compensation for each color on the liquid crystal panel 100, without any increase in the number of the wirings for the grayscale voltages of the driver 200. That is, the grayscale voltage is outputted for each color. Thus, for example, when the red (R), the green (G) and the blue (B) are respectively six bits, it is enough for the number of the wirings to be 2⁶=64, and it is not required to be 2⁶×3=192.

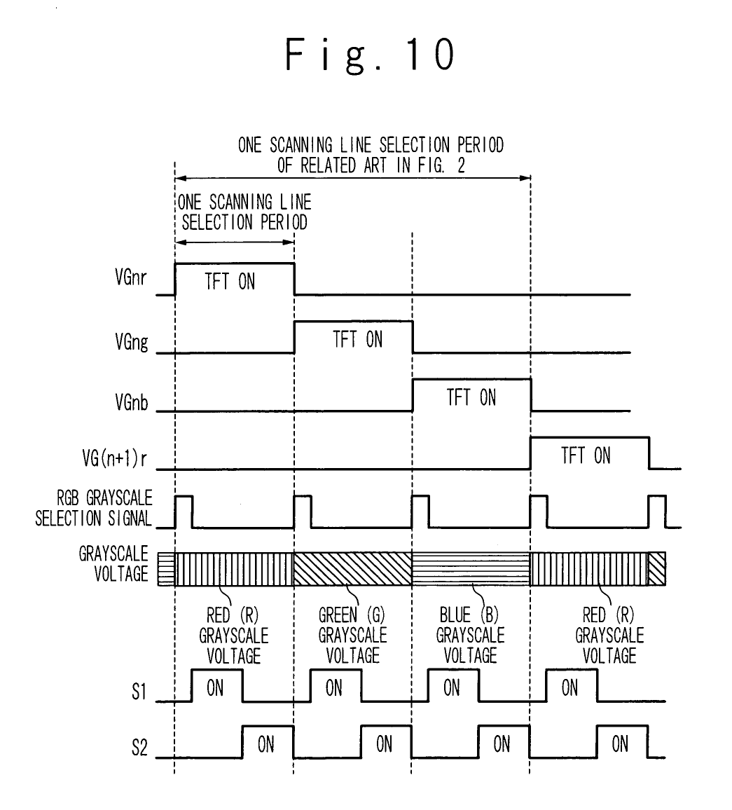

An operation of another embodiment of the liquid crystal display device (a method of driving the liquid crystal display device) according to the present invention will be described below with reference to FIG. 10. However, FIG. 10 is a timing chart showing the operation of another embodiment of the liquid crystal display device according to the present invention. This method of driving the liquid crystal display device differs from the embodiment in FIG. 7 in that the input time of the RGB grayscale selection signal is set at the beginning of the selection period for each scanning line. Here, the operation from the scanning line Gnr is explained as an example.

That is, for example, in the scanning line selection period of the red (R) (the selection period of VGnr), the control circuit 206 outputs the R-grayscale selection signal to the RGB variable grayscale voltage generating circuit 207. The RGB variable grayscale voltage generating circuit 207 outputs a plurality of grayscale voltages for the red (R) to the D/A converter 204, in response to the R-grayscale selection signal. The red (R) grayscale voltage is continuously outputted in the scanning line selection period for the red (R). The D/A converter 204 outputs the red (R) grayscale voltage corresponding to the R-data to the amplifier 25, based on the plurality of grayscale voltages for the red (R) and the R-data from the latch 203.

On the other hand, the scanning line decoder (not shown) activates the scanning lines Gnr, which is connected to the R-pixel Cn1R and the R-pixel Cn2R on the n-th line, in response to the control signal from the driver 200. Thus, the TFTs 11 in the R-pixel Cn1R and the R-pixel Cn2R are turned on. Hence, the R-pixel Cn1R and the R-pixel Cn2R become in the writable state. The amplifier 25 serially supplies the write voltages, which are written to the R-pixel Cn1R and the R-pixel Cn2R, to the input terminal 14.

When the write voltage written to the R-pixel Cn1R is supplied to the input terminal 14, the control circuit 206, after outputting the R-grayscale selection signal to the RGB variable grayscale voltage generating circuit 207, outputs the control signal S1 in synchronization with the supply of the write voltage. Thus, the switching element 13D1 is turned on, and the signal line D1 is selected. At this time, since the control signal S2 is not outputted, the switching element 13D2 is off. As a result, the write voltage written to the R-pixel Cn1R is supplied through the signal line D1 to the R-pixel Cn1R.

After that, when the write voltage written to the R-pixel Cn2R is supplied to the input terminal 14, the control circuit 206 outputs the control signal S2 in synchronization with the supply of the write voltage. Thus, the switching element 13D2 is turned on, and the signal line D2 is selected. At this time, since the control signal S1 is not outputted, the switching element 13D1 is off. As a result, the write voltage written to the R-pixel Cn2R is supplied through the signal line D2 to the R-pixel Cn2R.

In this way, the control circuit 206 sequentially and exclusively turns on and off the switching elements 13D1, 13D2 so that the write voltages written to the R-pixel Cn1R and the R-pixel Cn2R are supplied to the corresponding signal lines D1, D2.

This is similar even in the scanning line selection period for the green (G) (the selection signal of VGng) and the scanning line selection period of the blue (B) (the selection signal of VGnb).

Even in the other embodiments, it is possible to get the effect similar to those of the above-mentioned embodiments. In addition, without any increase in the number of the wirings of the grayscale voltage of the driver 200, it is possible to attain the gamma compensation for each color on the liquid crystal panel 100.

According to the present invention, when one amplifier is used to drive a plurality of signal lines in time sharing in a liquid crystal display device, image quality of a liquid crystal panel can be improved.

It is apparent that the present invention is not limited to the above embodiment, but may be modified and changed without departing from the scope and spirit of the invention.

What is claimed is:

1. A liquid crystal display device comprising:
a liquid crystal panel; and
a driving unit configured to drive said liquid crystal panel;
wherein said liquid crystal panel includes:
a plurality of scanning lines configured to extend in a first direction,
a plurality of signal lines configured to extend in a second direction, and
a plurality of pixels configured to be arranged in positions where said plurality of scanning lines intersects with said plurality of signal lines, wherein pixels which are included in said plurality of pixels and aligned along one of said plurality of scanning lines have a same color,
wherein said driving unit includes:
a plurality of amplifiers configured to drive said plurality of signal lines,
wherein said driving unit controls each of said plurality of amplifiers in time sharing such that each of said plurality of amplifiers drives pixels of a first group connected to one scanning line of said plurality of scanning line in said plurality of pixels in a first period in a scanning line selection period, and drives pixels of a second group connected to said one scanning line in a second period in said scanning line selection period.

2. The liquid crystal display device according to claim 1, wherein pixels included in said plurality of pixels, aligned along said one of the plurality of scanning lines and having the same color have a same polarity to each other.

3. The liquid crystal display device according to claim 1, wherein said driving unit controls said each of the plurality of amplifiers in time sharing, firstly with respect to pixels of a first color aligned along a first scanning line of said plurality of scanning lines in said plurality of said pixels, and then with respect to pixels of a second color aligned along a second scanning line of said plurality of scanning lines in said plurality of said pixels, and
said second scanning line is adjacent to said first scanning line.

4. The liquid crystal display device according to claim 1, wherein said liquid crystal panel includes:
a plurality of first switches configured to be provided between a plurality of first signal lines connected to said pixels of said first group in said plurality of signal lines and said plurality of amplifiers, and
a plurality of second switches configured to be provided between a plurality of second signal lines connected to said pixels of said second group in said plurality of signal lines and said plurality of amplifiers,
wherein said driving unit controls said each of the plurality of amplifiers in time sharing, by synchronizing said plurality of amplifiers with said plurality of first switches and said plurality of second switches.

5. The liquid crystal display device according to claim 1, wherein a pixel of a first color, a pixel of a second color and a pixel of a third color aligned along one of said plurality of signal lines constitute a pixel set in said plurality of pixels.

6. The liquid crystal display device according to claim 1, further comprising:
a reference grayscale voltage generating unit configured to generate reference grayscale voltages corresponding to grayscale voltage properties in respective colors of a first color, a second color and a third color in said liquid crystal panel,
wherein said reference grayscale voltage generating unit switches a grayscale voltage property corresponding to an input grayscale data applied to pixels, which are included in said plurality of pixels, aligned along said one of the plurality of scanning lines and have the same color, to each reference grayscale voltage corresponding to a grayscale voltage property of each of said first color, said second color and said third color, for each scanning of said plurality of scanning lines of respective colors of said first color, said second color and said third color.

7. A method of driving a liquid crystal display device, wherein a plurality of signal lines is driven by one amplifier comprising:
selecting a plurality of pixels aligned along one scanning line in one scanning line selection period,
driving pixels of a first group in said selected plurality of pixels in a first period in said scanning line selection period by said one amplifier,
driving pixels of a second group in said selected plurality of pixels in a second period in said scanning line selection period by said one amplifier.

8. The method of driving a liquid crystal display device according to claim 7, wherein said selected plurality of pixels aligned along said one scanning line and having a same color have a same polarity to each other in said driving pixels step of said first group and said driving pixels step of said second group.

9. The method of driving a liquid crystal display device according to claim 7, wherein said selecting step, said driving pixels step of said first group and said driving pixels step of said second group are executed, firstly with respect to pixels of a first color aligned along a first scanning line in a plurality of said pixels, and then with respect to pixels of a second color aligned along a second scanning line adjacent to said first scanning line in said plurality of said pixels.

10. A method of driving a liquid crystal display device, comprising:
providing said liquid crystal display device, wherein said liquid crystal display device includes:
a liquid crystal panel; and
a driving unit configured to drive said liquid crystal panel;
wherein said liquid crystal panel includes:
a plurality of scanning lines configured to extend in a first direction,
a plurality of signal lines configured to extend in a second direction, and
a plurality of pixels configured to be arranged in positions where said plurality of scanning lines intersects with said plurality of signal lines, wherein pixels which are included in said plurality of pixels and aligned along one of said plurality of scanning lines have a same color,
wherein said driving unit includes:
a plurality of amplifiers configured to drive said plurality of signal lines,
selecting pixels included in said plurality of pixels and aligned along one scanning line of said plurality of scanning lines in one scanning line selection period,
driving pixels of a first group in said selected pixels in a first period in said scanning line selection period by said plurality of amplifiers,
driving pixels of a second group in said selected pixels in a second period in said scanning line selection period by said plurality of amplifiers.

11. The method of driving a liquid crystal display device according to claim 10, wherein said selected pixels aligned along said one scanning line and having the same color have a same polarity to each other.

12. The method of driving a liquid crystal display device according to claim 10, wherein said selecting step, driving pixels step of said first group and driving pixels step of said second group are executed, firstly with respect to pixels of a first color aligned along a first scanning line of said plurality of scanning lines in said plurality of said pixels, and then with respect to pixels of a second color aligned along a second scanning line of said plurality of scanning lines in said plurality of said pixels, and
said second scanning line is adjacent to said first scanning line.
